(19) United States
(12) Patent Application Publication
(10) Pub. No.: US 2015/0142576 A1
(43) Pub. Date: May 21, 2015

(54) METHODS AND MOBILE DEVICES FOR DISPLAYING AN ADAPTIVE ADVERTISEMENT OBJECT AND SYSTEMS FOR GENERATING THE ADAPTIVE ADVERTISEMENT OBJECT

(71) Applicant: INSTITUTE FOR INFORMATION INDUSTRY, Taipei (TW)

(72) Inventors: Shih-Chun Chou, Taipei City (TW); Bo-Fu Liu, Tainan City (TW); Jih-Yiing Lin, Chiayi County (TW); Yu-Hung Lin, Kaohsiung City (TW)

(73) Assignee: INSTITUTE FOR INFORMATION INDUSTRY, Taipei (TW)

(21) Appl. No.: 14/271,601

(22) Filed: May 7, 2014

(30) Foreign Application Priority Data
Nov. 20, 2013 (TW) 102142282

(51) Int. Cl. G06Q 30/02

(52) U.S. Cl. CPC G06Q 30/0267
USPC 705/14.64

(57) ABSTRACT

A method for displaying an adaptive advertisement object on a mobile device, the method includes the following steps. Execute a mobile application to display a page including at least one adaptive advertisement object. The mobile application includes a description file, at least one content resource file, at least one advertisement resource file and a parsing module. The resource file includes at least one content object being displayed on the page. The description file includes a content description and an advertisement object description. The advertisement object description includes at least one keyword, at least one visual characteristic and at least one advertisement presentation description. The advertisement resource file is acquired from an advertisement resource file database. The parsing module displays the page including the adaptive advertisement object according to the content description and the advertisement presentation description of the description file, the content resource file, and the advertisement resource file.

### RELATED APPLICATIONS

This application claims priority to Taiwan Application Serial Number 102142282, filed Nov. 20, 2013, the entirety of which is herein incorporated by reference.

### BACKGROUND

1. Technical Field

The present disclosure relates to methods and mobile devices for displaying an adaptive advertisement object, and systems for generating the adaptive advertisement object, and more particularly, to methods and mobile devices for displaying an adaptive advertisement object in a mobile application, and systems for generating the adaptive advertisement object in the mobile application.

2. Description of Related Art

As the development of mobile devices, more and more services can be provided by the mobile devices. By installing mobile applications into the mobile devices, various services can be provided to users.

Therefore, more and more companies insert advertisements in the mobile applications to attract consumers. However, when the advertisement is inserted into the application, the visual presentation of the advertisement on the mobile application page is commonly not considered. Under this circumstance, the inserted advertisement often does not fit the visual design of the page, and consequently the inserted advertisement results in negative user experience or is overlooked by the user.

Therefore, it is very important in this field to insert an advertisement, which fits the visual design of the page, into the page of the application.

### SUMMARY

In one aspect, the present disclosure is related to a method for displaying an adaptive advertisement object on a mobile device, the method includes the following steps. A processing unit of the mobile device executes a mobile application to display a page including at least one adaptive advertisement object on a display unit of the mobile device. The mobile application includes a description file, at least one content resource file, at least one advertisement resource file and a parsing module. The at least one content resource file includes at least one content object being displayed on the page. The description file includes a content description corresponding to the presentation of the at least one content object, and an advertisement object description corresponding to the presentation of the at least one adaptive advertisement object. The advertisement object description includes at least one keyword, at least one visual characteristic and at least one advertisement presentation description. The at least one advertisement presentation description includes a display location description and a display size description for the corresponding advertisement resource file of the at least one adaptive advertisement object to be displayed on the display unit of the mobile device. The at least one advertisement resource file is acquired from an advertisement resource file database according to the at least one keyword, the at least one visual characteristic and the display size description. The parsing module displays the page including the at least one adaptive advertisement object on the display unit according to the content description and the at least one advertisement presentation description of the description file, the at least one content resource file, and the at least one advertisement resource file.

In another aspect, the present disclosure is related to a mobile device for displaying an adaptive advertisement object, in which the mobile device includes a processing unit and a display unit. The processing unit executes a mobile application to display a page including at least one adaptive advertisement object on the display unit of the mobile device. The mobile application includes a description file, at least one content resource file, at least one advertisement resource file and a parsing module. The at least one content resource file includes at least one content object being displayed on the page. The description file includes a content description corresponding to the presentation of the at least one content object, and an advertisement object description corresponding to the presentation of the at least one adaptive advertisement object. The advertisement object description includes at least one keyword, at least one visual characteristic and at least one advertisement presentation description. The at least one advertisement presentation description includes a display location description and a display size description for the corresponding advertisement resource file of the at least one adaptive advertisement object to be displayed on the display unit of the mobile device. The at least one advertisement resource file is acquired from an advertisement resource file database according to the at least one keyword, the at least one visual characteristic and the display size description. The parsing module is executed by the processing unit to display the page including the at least one adaptive advertisement object on the display unit according to the content description and the at least one advertisement presentation description of the description file, the at least one content resource file, and the at least one advertisement resource file.

In another aspect, the present disclosure is related to a system for generating an adaptive advertisement object. The system includes an advertisement resource file database and a processing unit. The advertisement resource file database includes a plurality of pre-saved advertisement file. The processing unit includes a generating module and an acquiring module. The generating module is used for generating a mobile application being configured for displaying a page comprising at least one adaptive advertisement object on the display unit of the mobile device. The mobile application includes a description file, at least one content resource file, at least one advertisement resource file and a parsing module. The at least one content resource file includes at least one content object being displayed on the page. The description file includes a content description corresponding to the presentation of the at least one content object, and an advertisement object description corresponding to the presentation of the at least one adaptive advertisement object. The advertisement object description includes at least one keyword, at least one visual characteristic and at least one advertisement presentation description. The at least one advertisement presentation description includes a display location description and a display size description for the corresponding advertisement resource file of the at least one adaptive advertisement object to be displayed on the display unit of the mobile device. The parsing module displays the page including the at least one adaptive advertisement object on the display unit according to the content description and the at least one advertisement presentation description of the description file, the at least one content resource file, and the at least one advertisement resource file. The acquiring module is used to acquire a matched pre-saved advertisement file to be the at least one advertisement resource file from the advertisement resource file database according to the at least one keyword, the at least one visual characteristic and the display size description.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a flow chart of a method for displaying an adaptive advertisement object in accordance with one embodiment of the present disclosure.

FIG. 2 is a block diagram of a mobile device for displaying an adaptive advertisement object in accordance with one embodiment of the present disclosure.

FIG. 3 is a block diagram of a system for generating an adaptive advertisement object in accordance with one embodiment of the present disclosure.

FIG. 4 is a block diagram of a system for generating an adaptive advertisement object in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

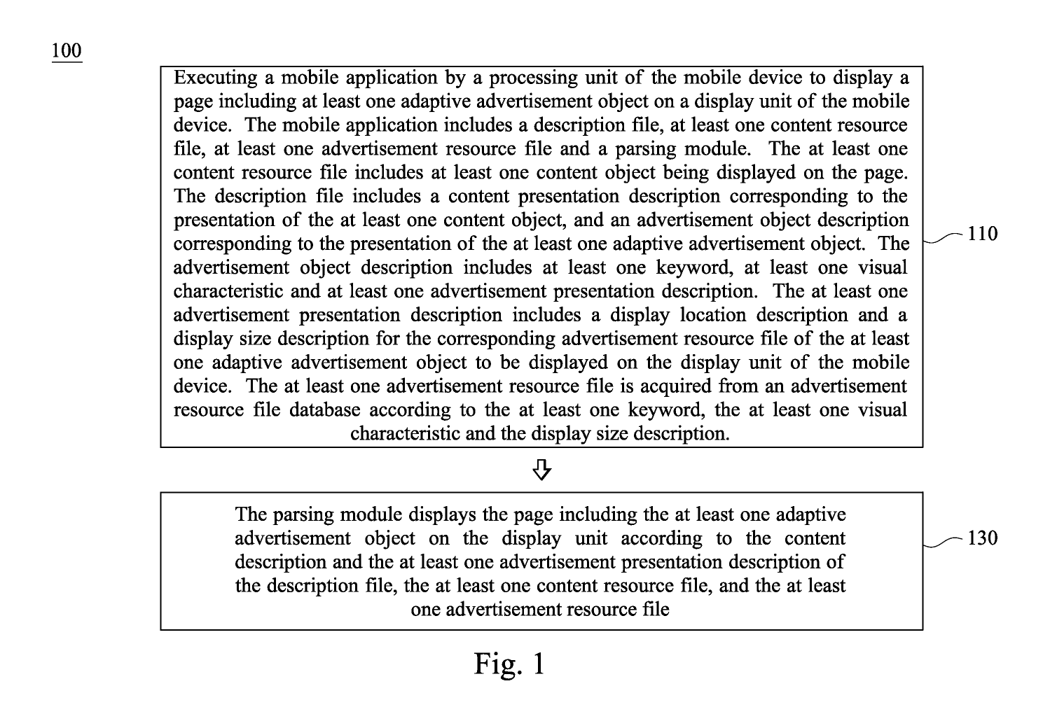

Reference is made first to FIG. 1. FIG. 1 is a schematic diagram of a method 100 for displaying an adaptive advertisement object in accordance with one embodiment of the present disclosure. By the method 100, an adaptive advertisement object is displayed for a mobile device according to some description files. The method 100 for displaying an adaptive advertisement object on a mobile device method may take the form of a computer program product stored on a computer-readable storage medium having computer-readable instructions embodied in the medium. Any suitable storage medium (such as non-transitory medium) may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. The method 100 of displaying an adaptive advertisement object is applicable on a mobile device.

The method 100 for displaying an adaptive advertisement object includes the following steps:

In step 110, execute a mobile application by a processing unit of the mobile device to display a page comprising at least one adaptive advertisement object on a display unit of the mobile device. In some embodiments of the present disclosure, the mobile device can download the mobile application through the Internet, or the mobile application can be pre-loaded into the mobile device such that the processing unit can execute the mobile application. The mobile application at least includes a description file, at least one content resource file, at least one advertisement resource file and a parsing module. The content resource file includes at least one content object being displayed on the page. For example, the content object may be text, pictures, video, frames, lines, operating options, linking address, or interactive operating object. The linking address is utilized to link to another page to display text, pictures, or video. The description file includes a content description corresponding to the presentation of the content object, and an advertisement object description corresponding to the presentation of the adaptive advertisement object. The advertisement object description includes at least one keyword, at least one visual characteristic and at least one advertisement presentation description. The advertisement presentation description includes a display location description and a display size description for the adaptive advertisement object to be displayed on the display unit of the mobile device (or, a display location description and a display size description for the corresponding advertisement resource file of the adaptive advertisement object to be displayed on the display unit of the mobile device). The presentation of content object and the adaptive advertisement object on the page can be set up in the content description and the advertisement presentation description, which can be displayed directly on an assigned display location according to assigned display size, or be displayed with an animation effect on the page. For example, flash, zoom in/out, slides or other types of presentations.

In some embodiments, the keyword and the visual characteristic can be set up in advance and saved in the description file, for example, they can be set up and saved when the page of the mobile application is designed. In other embodiments, the keyword and the visual characteristic can be generated automatically when the content resource file is analyzed by the page analysis module. The keyword is a word capable of representing the content object. For example, when the content object is a paragraph/article, the keyword can be obtained by calculating the frequency of words/terms having meanings in the paragraph/article through algorithms. The most frequent words/terms having meanings can be used as the keywords in the paragraph/article. In other embodiments, when the content object is a picture, the objects in the picture could be identified by analyzing the visual characteristics of the picture with an object visual characteristic database, the names or categories of the identified objects can be used as the keywords or used to find out the keyword.

In other embodiments, the visual characteristic is a descriptor of one of the description, the content, the name, the color, the color tone, the size, the texture, the strokes, the shape, the contour, the visual feature of the visual presentation of the at least one content resource file, other types of visual descriptions, and the combination thereof.

The advertisement presentation description at least includes a display location description, a display size description or other parameters determining the advertisement presentation effects for the at least one corresponding advertisement resource file of the adaptive advertisement object to be displayed on the page. The parsing module can be implemented in a programming language, and then compiled to a sequence of instructions which can be read and executed by the processing unit of the mobile device.

The advertisement resource file includes at least one adaptive advertisement object to be displayed on the page. The advertisement object of the advertisement resource file is acquired mainly from an advertisement resource file database according to the keyword, the visual characteristic and the display size description. In some embodiments, when the mobile application is generated, the adaptive advertisement object which meets the keyword, the visual characteristic and the display size of the description file can be acquired and saved as the advertisement resource file from an advertisement resource file database storing a plurality of advertisements objects. The number of the adaptive advertisement objects is not limited, in a preferred embodiment, the number is from 1 to 5. In other embodiments, when the processing unit of the mobile device executes the mobile application, the processing unit of the mobile device is connected to the advertisement resource database on the network through a communication unit and a communication network to acquire/update the advertisement resource file according to the keyword and the visual characteristic in the description file. In other embodiments, the advertisements resource database can be built in advance in the mobile device. When the mobile device executes the mobile application, the advertisement resource file is acquired/updated from the advertisement resource database of the mobile device according to the keyword and the visual characteristic in the description file

In step 130, the parsing module displays the page including the adaptive advertisement object on the display unit according to the content description and the advertisement presentation description of the description file, the content resource file, and the advertisement resource file. Thus the advertisements displayed on the mobile device will match the style of the page of the mobile application of the mobile device and effective advertising could be achieved. The parsing module can be implemented in a programming language, and then compiled to a sequence of instructions which can be read and executed by the processing unit of the mobile device. The parsing module can be a firmware, which is recorded in an IC component.

In some embodiments, when the advertisement resource database is linked to the communication network, it can be built in an advertisement matching server. Thus when the processing unit of the mobile device executes the mobile application, the processing unit of the mobile device is connected to the advertisement matching server through a communication unit and the communication network to acquire the at least one advertisement resource file according to the at least one keyword and the at least one visual characteristic in the description file.

Moreover, the advertisement resource file can be updated, that is, the adaptive advertisement object of the advertisement resource file can be replaced. When the processing unit of the mobile device executes the mobile application, the processing unit of the mobile device is further connected to the advertisement matching server through the communication unit and the communication network to acquire other advertisement resource files to update the advertisement resource file according to the at least one keyword and the at least one visual characteristic in the description file. Thus the advertisement object displayed on the page of the mobile device can be replaced. The advertisement displayed on the page of the mobile device is not fixed such that the effect of the advertisement is better.

In other embodiments, the number of the advertisement resource file is plural. Thus the parsing module can choose a specific advertisement resource file from the plural advertisement resource files according to a specific rule and display the adaptive advertisement object on the page according to at least one advertisement presentation description of the advertisement object description. The specific rule can be random, sequential or other ways.

In other embodiments, the advertisement resource file can further include information for its corresponding usage scenario, for example, the information may include locations, business district, weather, and festival. Thus the parsing module chooses a specific advertisement resource file from the plural advertisement resource files according to the current context information and displays the adaptive advertisement object on the page according to at least one advertisement presentation description of the advertisement object description. Thus by taking the usage scenario into consideration, the advertisement displayed will better fit the user's needs.

The interaction can also be taken into consideration in the method for displaying an adaptive advertisement object for the advertisement presentation. Thus the advertisement presentation description can further include an interaction description (for example, drag, click, pinch/spread, or other types of interaction). When the mobile device executes the parsing module, the parsing module displays the adaptive advertisement object on the page according to the interaction description and an input signal of the mobile device. Thus the corresponding advertisement objects can be displayed according to the input signal entered by the user through the mobile device when interacting.

In other embodiments, the display location and the display size of the adaptive advertisement object on the page are determined according to the analysis on the description file and the content resource file by a page analysis module. Since the interactive object is usually an important object for the user to interact with and the display setup of the interactive object is more complicated, it will be better that the display location and the display size of the interactive object are not overlapped when the page analysis module determines the display location and the display size of the advertisement object. The determining steps includes: identifying at least one interaction object from the content description of the description file and the content resource file; retrieving the display location and the display size of the interaction object; and determining a display location and a display size, which do not overlap the display location and the display size of the interaction object, for the adaptive advertisement object. Thus the situation that the adaptive advertisement object overlaps the content of the interactive object on the page can be avoided when the adaptive advertisement object is displayed.

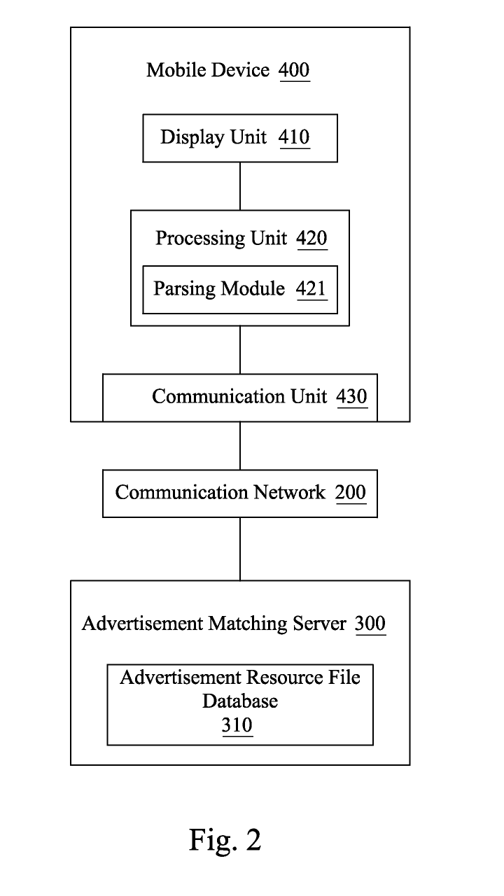

Reference is made also to FIG. 2. FIG. 2 is a block diagram of a mobile device 400 for displaying an adaptive advertisement object in accordance with one embodiment of the present disclosure. The mobile device 400 includes a display unit 410 and a processing unit 420. The processing unit 420 can be a Central Processing Unit (CPU), a control unit, a micro processor or other hardware units which can executes instructions and provide functions for the mobile device 400.

The processing unit 420 executes a mobile application to display a page including at least one adaptive advertisement object on the display unit 410 of the mobile device 400. The mobile application includes a description file, at least one content resource file, at least one advertisement resource file and a parsing module 421.

The content resource file includes at least one content object being displayed on the page. The description file includes a content description corresponding to the presentation of the content object, and an advertisement object description corresponding to the presentation of the adaptive advertisement object. The advertisement object description includes at least one keyword, at least one visual characteristic and at least one advertisement presentation description. The advertisement presentation description includes a display location description and a display size description for the corresponding advertisement resource file of the adaptive advertisement object to be displayed on the display unit of the mobile device.

The advertisement resource file includes at least one adaptive advertisement object to be displayed on the page. The advertisement resource file is acquired from an advertisement resource file database 310 according to the keyword, the visual characteristic and the display size description.

Then the processing unit 420 of the mobile device 400 executes the parsing module 421 to display the page including the at least one adaptive advertisement object on the display unit 410 according to the content description and the advertisement presentation description of the description file, the content resource file, and the advertisement resource file. Thus the advertisements displayed on the mobile device 400 will match the style of the page of the mobile application of the mobile device 400 and effective advertising could be achieved.

In some embodiments, the mobile device 400 further includes a communication unit 430. The communication unit 430 can be an Ethernet or a wireless network card which is configured for connecting to a communication network 200 through Ethernet or wireless network communication protocols. The advertisement resource file database 310 is built in an advertisement matching server 300. Thus when the processing unit 420 executes the mobile application, the processing unit 420 is connected to the advertisement matching server 300 through a communication unit 430 and a communication network 200 to acquire the advertisement resource file to be displayed on the display unit 410 according to the keyword and the visual characteristic in the description file.

Moreover, when the processing unit 420 executes the mobile application, the processing unit 420 can further be connected to the advertisement matching server 300 through a communication unit 430 and a communication network to acquire other advertisement resource files from the advertisement matching server 300 to update the advertisement resource file according to the keyword and the visual characteristic in the description file. Thus different advertisement resource files can be acquired to be displayed on the display unit 410.

Furthermore, the mobile device 400 further includes current context information. In some embodiments, the processing unit 420 can simultaneously compute the current context information. In other embodiments, the user can operate the mobile device 400 to set up the current context information. In other embodiments, the current context information can be set up according to other ways and is not limited herein. Moreover, the number of the advertisement resource files is plural, and each of the advertisement resource files further includes information for its corresponding usage scenario. Thus the processing unit 420 executes the parsing module 421 to choose a specific advertisement resource file from the plural advertisement resource files according to the current context information and displays the adaptive advertisement object on the page displayed on the display unit 410 according to at least one advertisement presentation description of the advertisement object description. Thus by taking the usage scenario into consideration, the advertisement displayed will better fit the user's needs.

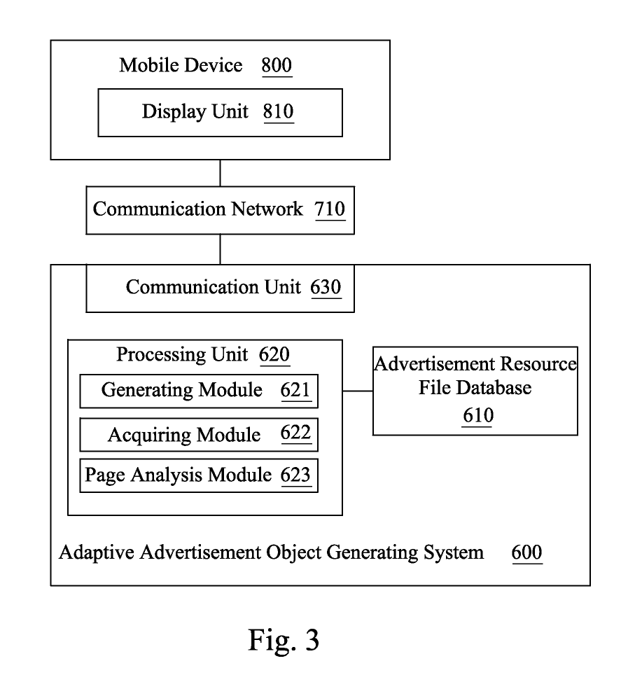

Additional reference is made to FIG. 3. FIG. 3 is a block diagram of a system 600 for generating an adaptive advertisement object in accordance with one embodiment of the present disclosure. The system 600 includes an advertisement resource file database 610 and a processing unit 620. In some embodiments, the advertisement resource file database 610 and the processing unit 620 can be allocated in the same server, or different servers.

The advertisement resource file database 610 can be stored in a storage unit. The storage unit can be a read only memory, a flash memory, a floppy disk drive, a hard disk drive (HDD), a compact disc read only memory (CD-ROM), a USB disk, a magnetic storage device, a database which can be accessed via networks or other type of storage units. The advertisement resource file database 610 includes a plurality of pre-saved advertisement file.

The processing unit 620 can be a Central Processing Unit (CPU), a control unit, a micro processor or other hardware component which can executes instructions. Each module of the processing unit 620 can be implemented as codes, which can be accessed by the processing unit 620 and provide corresponding functions.

The processing unit 620 includes a generating module 621 and an acquiring module 622. The generating module 621 is used for generating a mobile application being configured for displaying a page including at least one adaptive advertisement object on the display unit 810 of the mobile device 800. The mobile application includes a description file, at least one content resource file, at least one advertisement resource file and a parsing module. The content resource file includes at least one content object being displayed on the page. The description file includes a content description corresponding to the presentation of the content object, and an advertisement object description corresponding to the presentation of the adaptive advertisement object. The advertisement object description includes at least one keyword, at least one visual characteristic and at least one advertisement presentation description. The presentation of content object and the adaptive advertisement object on the page can be set up in the content description and the advertisement presentation description, which can be displayed directly on an assigned display location according to assigned display size, or be displayed with an animation effect on the page. For example, flash, zoom in/out, slides or other types of presentations. Moreover, the processing unit 620 can further include a page analysis module 623, which is configured for analyzing content resource file to generate the key word and the visual characteristic.

In some embodiments, the visual characteristic is a descriptor of one of the description, the content, the name, the color, the color tone, the size, the texture, the strokes, the shape, the contour, the visual feature of the visual presentation of the at least one content resource file, other types of visual descriptions, or the combination thereof.

The advertisement presentation description includes a display location description, a display size description or other parameters determining the advertisement presentation effects for the at least one corresponding advertisement resource file of the adaptive advertisement object to be displayed on the page. The parsing module can be implemented as a code for the mobile device 800 to read and execute.

The advertisement resource file includes the adaptive advertisement object to be displayed on the page. The parsing module of the mobile application is executed to display the page including the adaptive advertisement object on the display unit 810 of the mobile device 800 according to the content description and the at least one advertisement presentation description of the description file, the content resource file, and the advertisement resource file.

The acquiring module 622 is used to acquire a matched pre-saved advertisement file to be the advertisement resource file from the advertisement resource file database 610 according to the keyword, the visual characteristic and the display size description. Thus after installing the mobile application generated by the generating system 600 on the mobile device 800, the advertisements displayed by executing the mobile application will match the style of the page of the mobile application and effective advertising could be achieved.

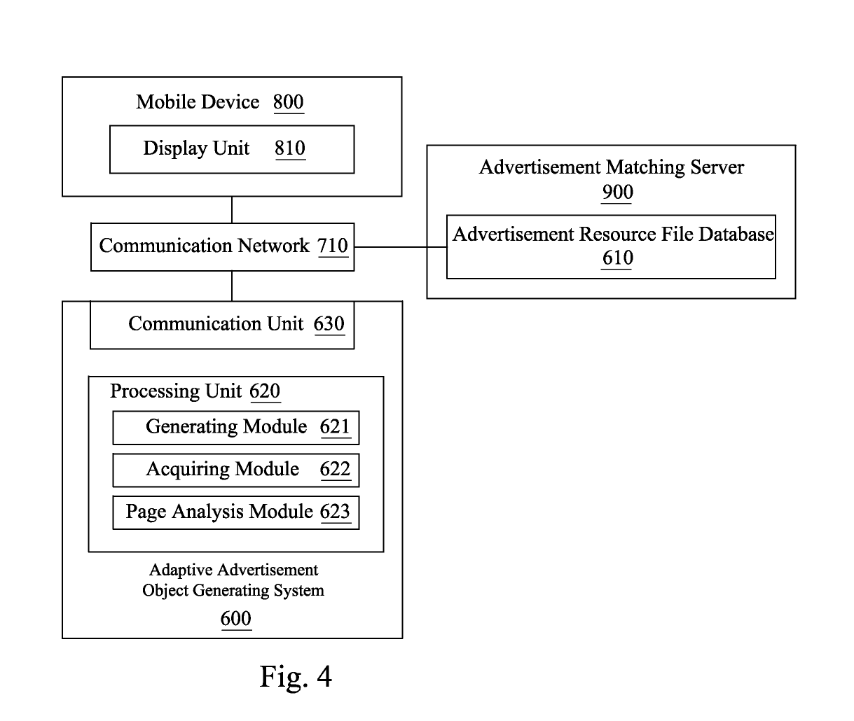

Reference is now made to FIG. 4. FIG. 4 is a block diagram of a system 600 for generating an adaptive advertisement object in accordance with one embodiment of the present disclosure.

The system 600 can further include a communication unit 630, and the advertisement resource file database 610 is built in an advertisement matching server 900. Thus the acquiring module 622 is connected to the advertisement matching server 900 through the communication unit 630 and a communication network 710. Then the acquiring module 622 acquires the matched pre-saved advertisement file in the advertisement resource file database 610 to be the advertisement resource file according to the keyword and the visual characteristic in the description file.

Moreover, the system 600 can transmit the mobile application to the mobile device 800 through the communication unit 630 and a communication network 710 such that the mobile application can be executed on the mobile device 800. When the mobile device 800 executes the mobile application, the mobile device 800 can further be connected to the advertisement matching server 900 through the communication network 710 to acquire other advertisement resource files from the advertisement matching server 900 to update the advertisement resource file according to the keyword and the visual characteristic in the description file. Thus different advertisement resource files can be acquired to be displayed on the display unit 810 of the mobile device 800.

In other embodiments, the advertisement description can further include an interaction description (for example, drag, click, pinch/spread, or other types of interaction). Thus when the mobile device 800 executes the parsing module, the parsing module displays the adaptive advertisement object on the page displayed on the display unit 810 according to the interaction description and an input signal of the mobile device 800. Thus corresponding advertisement objects can be displayed according to the input signal entered by the user through the mobile device when interacting.

In some embodiments, the page analysis module 623 can analyze the description file and the content resource file to determine the display location and the display size of the adaptive advertisement object. The page analysis module 623 identifies at least one interaction object from the content description of the description file and the at least one content resource file, and retrieves the display location and the display size of the interaction object. Thus the page analysis module 623 determines a display location and a display size, which do not overlap the display location and the display size of the interaction object, for the adaptive advertisement object. Thus the situation that the adaptive advertisement object overlaps other content on the page can be avoided when the adaptive advertisement object is displayed.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for displaying an adaptive advertisement object on a mobile device, comprising:
executing a mobile application by a processing unit of the mobile device to display a page comprising at least one adaptive advertisement object on a display unit of the mobile device, wherein the mobile application comprises a description file, at least one content resource file, at least one advertisement resource file and a parsing module; and wherein
the at least one content resource file comprises at least one content object being displayed on the page;
the description file comprises a content description corresponding to the presentation of the at least one content object, and an advertisement object description corresponding to the presentation of the at least one adaptive advertisement object, wherein the advertisement object description comprises at least one keyword, at least one visual characteristic and at least one advertisement presentation description wherein the at least one advertisement presentation description comprises a display location description and a display size description for the corresponding advertisement resource file of the at least one adaptive advertisement object to be displayed on the display unit of the mobile device;
the at least one advertisement resource file is acquired from an advertisement resource file database according to the at least one keyword, the at least one visual characteristic and the display size description; and
the parsing module displays the page comprising the at least one adaptive advertisement object on the display unit according to the content description and the at least one advertisement presentation description of the description file, the at least one content resource file, and the at least one advertisement resource file.

2. The method of claim 1, wherein the advertisement resource file database is built in an advertisement matching server, and when the processing unit of the mobile device executes the mobile application, the processing unit of the mobile device is connected to the advertisement matching server through a communication unit and a communication network to acquire the at least one advertisement resource file according to the at least one keyword and the at least one visual characteristic in the description file.

3. The method of claim 2, wherein when the processing unit of the mobile device executes the mobile application, the processing unit of the mobile device is connected to the advertisement matching server through a communication unit and a communication network to acquire other advertisement resource file to update the at least one advertisement resource file according to the at least one keyword and the at least one visual characteristic in the description file.

4. The method of claim 1, wherein the number of the at least one advertisement resource file is plural, and the parsing module chooses a specific advertisement resource file from the plural advertisement resource files according to a specific rule and displays the adaptive advertisement object on the page according to at least one advertisement presentation description of the advertisement object description.

5. The method of claim 1, wherein the mobile device further comprises current context information, the number of the at least one advertisement resource file is plural, each of the advertisement resource files further comprises information for its corresponding usage scenario and the parsing module chooses a specific advertisement resource file from the plural advertisement resource files according to the current context information and displays the adaptive advertisement object on the page according to at least one advertisement presentation description of the advertisement object description.

6. The method of claim 1, wherein the at least one advertisement presentation description further comprises an interaction description, and the parsing module displays the adaptive advertisement object on the page according to the interaction description and an input signal of the mobile device.

7. The method of claim 1, wherein the at least one keyword is a word capable of representing the at least one content object, and wherein the at least one visual characteristic is a descriptor of one of the description, the content, the name, the color, the color tone, the size, the texture, the strokes, the shape, the contour and the visual feature of the visual presentation of the at least one content resource file.

8. The method of claim 7, wherein the at least one keyword and the at least one visual characteristic are generated according to the analysis on the at least one content resource file by a page analysis module.

9. The method of claim 1, wherein the display location and the display size of the at least one adaptive advertisement object are determined according to the analysis on the description file and the at least one content resource file by a page analysis module, and the determining steps comprise:
identifying at least one interaction object from the content description of the description file and the at least one content resource file;
retrieving the display location and the display size of the at least one interaction object; and
determining a display location and a display size, which do not overlap the display location and the display size of the at least one interaction object, for the at least one adaptive advertisement object.

10. A mobile device for displaying an adaptive advertisement object, comprising:
a processing unit and a display unit, wherein the processing unit executes a mobile application to display a page comprising at least one adaptive advertisement object on the display unit of the mobile device, wherein the mobile application comprises a description file, at least one content resource file, at least one advertisement resource file and a parsing module; and wherein the at least one content resource file comprises at least one content object being displayed on the page;
the description file comprises a content description corresponding to the presentation of the at least one content object, and an advertisement object description corresponding to the presentation of the at least one adaptive advertisement object, wherein the advertisement object description comprises at least one keyword, at least one visual characteristic and at least one advertisement presentation description, wherein the at least one advertisement presentation description comprises a display location description and a display size description for the corresponding advertisement resource file of the at least one adaptive advertisement object to be displayed on the display unit of the mobile device; the at least one advertisement resource file is acquired from an advertisement resource file database according to the at least one keyword, the at least one visual characteristic and the display size description; and
the parsing module is executed by the processing unit to display the page comprising the at least one adaptive advertisement object on the display unit according to the content description and the at least one advertisement presentation description of the description file, the at least one content resource file, and the at least one advertisement resource file.

11. The mobile device of claim 10, wherein the mobile device further comprises a communication unit, the advertisement resource file database is built in an advertisement matching server, and when the processing unit executes the mobile application, the processing unit of the mobile device is connected to the advertisement matching server through the communication unit and a communication network to acquire the at least one advertisement resource file according to the at least one keyword and the at least one visual characteristic in the description file.

12. The mobile device of claim 11, wherein when the processing unit executes the mobile application, the processing unit is connected to the advertisement matching server through the communication unit and the communication network to acquire other advertisement resource file to update the at least one advertisement resource file according to the at least one keyword and the at least one visual characteristic in the description file.

13. The mobile device of claim 11, wherein the mobile device further comprises current context information, the number of the at least one advertisement resource file is plural, each of the advertisement resource files further comprises information for its corresponding usage scenario, and the parsing module chooses a specific advertisement resource file from the plural advertisement resource files according to the current context information and displays the adaptive advertisement object on the page according to at least one advertisement presentation description of the advertisement object description.

14. A system for generating an adaptive advertisement object comprising:
an advertisement resource file database comprising a plurality of pre-saved advertisement file; and
a processing unit comprising a generating module and an acquiring module, wherein
the generating module is used for generating a mobile application being configured for displaying a page comprising at least one adaptive advertisement object on the display unit of the mobile device, wherein the mobile application comprises a description file, at least one content resource file, at least one advertisement resource file and a parsing module; and wherein the at least one content resource file comprises at least one content object being displayed on the page; the description file comprises a content description corresponding to the presentation of the at least one content object, and an advertisement object description corresponding to the presentation of the at least one adaptive advertisement object, wherein the advertisement object description comprises at least one keyword, at least one visual characteristic and at least one advertisement presentation description, wherein the at least one advertisement presentation description comprises a display location description and a display size description for the corresponding advertisement resource file of the at least one adaptive advertisement object to be displayed on the display unit of the mobile device; and the parsing module displays the page comprising the at least one adaptive advertisement object on the display unit according to the content description and the at least one advertisement presentation description of the description file, the at least one content resource file, and the at least one advertisement resource file; and
the acquiring module is used to acquire a matched pre-saved advertisement file to be the at least one advertisement resource file from the advertisement resource file database according to the at least one keyword, the at least one visual characteristic and the display size description.

15. The system of claim 14, wherein the system further comprises a communication unit, the advertisement resource file database is built in an advertisement matching server, and the acquiring module is connected to the advertisement matching server through the communication unit and a communication network so as to acquire the matched pre-saved advertisement file to be the at least one advertisement resource file according to the at least one keyword and the at least one visual characteristic in the description file.

16. The system of claim 15, wherein the mobile application to be executed in the mobile device is transmitted by the system through the communication unit and the communication network, and when the mobile device executes the mobile application, the mobile device is connected to the advertisement matching server through the communication network to acquire other advertisement resource file to update the at least one advertisement resource file according to the at least one keyword and the at least one visual characteristic in the description file.

17. The system of claim 14, wherein the at least one advertisement presentation description further comprises an interaction description, and the parsing module displays the adaptive advertisement object on the page according to the interaction description and an input signal of the mobile device.

18. The system of claim 14, wherein the at least one keyword is a word capable of representing the at least one content object, and wherein the at least one visual characteristic is a descriptor of one of the description, the content, the name, the color, the color tone, the size, the texture, the strokes, the shape, the contour and the visual feature of the visual presentation of the at least one content resource file.

19. The system of claim 18, wherein the processing unit further comprises:
a page analysis module being used for analyzing the at least one content resource file to generate the at least one keyword and the at least one visual characteristic.

20. The system of claim 14, wherein the processing unit further comprises:
a page analysis module being used for analyzing the description file and the at least one content resource file to determine the display location and the display size of the at least one adaptive advertisement object, wherein the page analysis module identifies at least one interaction object from the content description of the description file and the at least one content resource file; retrieves the display location and the display size of the at least one interaction object; and determines a display location and a display size, which do not overlap the display location and the display size of the at least one interaction object, for the at least one adaptive advertisement object.
